(19) United States
(12) Patent Application Publication
(10) Pub. No.: US 2009/0208020 A1
(43) Pub. Date: Aug. 20, 2009

(54) Methods for Protecting from Pharming and Spyware Using an Enhanced Password Manager

(76) Inventor: Amiram Grynberg, Neve Efrayim Monoson (IL)

Correspondence Address: AMIRAM GRYNBERG, 24 RIMON ST, NEVE EFRAYIM MONSON, 60190, IL

(21) Appl. No.: 12/363,764

(22) Filed: Feb. 1, 2009

Related U.S. Application Data
(60) Provisional application No. 61/028,924, filed on Feb. 15, 2008.
(60) Provisional application No. 61/039,437, filed on Mar. 26, 2008.

(51) Int. Cl. H04L 9/32; G06F 21/00; H04L 9/00

(52) U.S. Cl. 380/277; 726/5

(57) ABSTRACT

Methods implemented by enhanced Password Manager for protecting against Pharming and Spyware comprising matching a saved record with certificate of website and withholding saved record's data if a match is not found. Further comprising, scrambling of retrieved data with a scrambling key wherein said key is synchronized with website.

### CROSS REFERENCE TO RELATED APPLICATIONS

Provisional Applications Ser. Nos. 61/028,924 and 61/039,437, the benefit of which is hereby claimed under 35 U.S.C. .sctn. 119 (e), and wherein said provisional applications are further incorporated herein by reference.

### BACKGROUND OF THE INVENTION

The internet in general and the World Wide Web in particular, help people and organizations connect with each other for business and pleasure. However, the Internet also proves to be a new play media for scamming and fraud.

As more people (Users) enter personal and private data into Web forms through web browsers, other parties (Attackers) have looked for ways to defraud users and retrieve said personal data using various methods.

In particular, a method called “Phishing” has become popular recently. Using that method, an attacker prepares a bogus web site that resembles a real existing site (cloned site). The attacker then sends an email to a user prompting said user to visit the spoofed web site for important business related to the cloned site. Many times the cloned sites are financial institutions or other organizations where users have accounts with.

Another mode of attack is called Pharming. By poisoning a Domain Name Server database, an attacker may cause users who type a correct URL at their browser to be directed to the wrong IP address, thus allowing creating a similar situation as phishing.

Pharming can also take place local to a user's computer. A spyware program may change the routing tables used by a computer to resolve a URL address, thus causing a browser to be directed to the wrong address.

Phishing and Pharming are special cases of what is generally known as man-in-the-middle-attack in the art of cryptography. (MITM)

A user visiting the spoofed site is asked to enter secret credentials into an online form as part of the ‘identification process’. Since the spoofed site seems similar to a real site the user may be doing business with, users fall into such a trap and provide secret information like passwords, credit card numbers and other related information.

The most common problem is one of stealing a User's password whether it is regular password or what is known as One Time Password (OTP).

When a User is presented with a login page to a website, the information that is entered into the login form is sent to a website (Server) for authentication. If the information contains a password, then an imposter site (Attacker) can retrieve the password and save it for later use. If however, the login information contains a OTP, then the usefulness of such information is time limited.

The above discussion is relevant to MITM attacks whereby the information is collected and later used. However, there are cases of real-time MITM attacks whereby the capture information is used in real-time by some automatic mechanism or even by manual methods for cases where a specific User is targeted.

Even if a Server uses a secure protocol to handle the login process, it does not prevent MITM attacks. This is true if the User does not possess a User certificate allowing a non-anonymous secure session to be opened.

When a User accesses a login page of a Server, the MITM attacker actually creates the session with the Server. The server has no way of knowing that this is not the real User doing so. Information sent by Server to User is passed on by Attacker to User and vice versa.

Financial institutions and others are actively looking for solution to these problem. (see http://www.antiphishing.org/ for case studies and working committees, which is incorporated here by reference).

A readily available solution to phishing (but not Pharming) is a common tool known as ‘password manager’.

A password manager stores login credentials for websites in an encrypted database. Whenever a user navigates to a page which requires a login, the password manager, which monitors such activities in the background, compares the URL of the site with the list of stored URLs (or parts thereof) in its database. If a match is found, the password manager reacts by automatically filling in the requested login credentials. Alternatively, it prompts the user for permission to do so or it waits for the user to request such login data.

When a user is directed to a phishing website, a password manager is not fooled by visual forgery which makes a phishing website look like a real one. A password manager only cares about URL address, which cannot be forged. Thus, a password manager will not fill-out a login form in a phishing website.

Since users who use password managers, become dependent on the tool, the very fact that a password manager ignores the site, is the protection they need from phishing.

This is, however, not the case with Pharming. With Pharming, the URL is correct, but the IP address is wrong. A standard password manager would react to this forged site as if it was a real one.

Thus, it would be beneficial to enhance a password manager with methods that could turn it into an anti-Pharming tool as well.

Another problem, not currently solved by password managers, is protection from spyware.

A spyware program can be maliciously installed by virus like programs, or it can be pre-installed in public computers, like internet café.

A spyware program can hook itself to a browser and captured any information entered by the password manager to a form, even before the form is submitted.

So, it would be very helpful if a password manager could be modified to send confidential data to a legitimate server in such a manner that a spying program would not be able to record that information.

### SUMMARY OF THE INVENTION

The current invention describes methods for enhancing password manager programs so that they provide protection from Pharming and spyware.

In a first method, a password manager response to a website is blocked if said website does not provide a proof of possession of a secret, to the password manager.

In a second method, a password manager replaces stored confidential data to be filled into a form with either a proof of possession of said data or with an encrypted version of the data, thus making it un useful to a spyware eavesdropping on the session between said password manager and a host

### BRIEF DESCRIPTIONS OF THE DRAWINGS

no drawings

### DETAILS OF THE INVENTION

The current invention describes methods for enhancing password manager programs (Enhanced Password Manager) so that they provide protection from Pharming and spyware.

An Enhanced Password Manager (EPM), for the purpose of this invention is an executable program and related data, usually an extension to a browser or part of a browser, wherein it helps a user in filling out online forms requiring confidential data stored by it.

An EPM can store its data in local storage, on a remote network/Internet resource or within a portable device communicative with the device where said PM is executing.

The confidential data handled by an EPM usually include passwords, which are specific to a particular website. But, it can also include other confidential data, not necessarily related to a website, such as social security number, credit card number etc.

An EPM also stores non confidential data like user names etc.

An EPM can interact with a browser in several modes: passive, interactive, fully automated.

In a passive mode, it waits for a user to request it to display/fill confidential data related to the current website.

In an interactive mode, it monitors pages presented to a user, if it detects a form which requires the stored confidential data it has for the current website, it prompts the user to get his or her permission for fill out the form.

A fully automated mode is similar to interactive mode, except that it does not prompt the user and it simply fills the form.

The term ‘current website’ is the key to the way an EPM functions. Confidential information is stored by an EPM in an encrypted database. Such database holds many records each holding data related to a particular website.

A record is deemed related, if the record key matches the URL of the current domain. How matching is performed is specific to an EPM. However, in most cases, a key is the domain name part of the URL. (mydomain.com would match www.mydomain.com/login/). However, other methods are well known as well.

Thus, it is enough for a URL to match a stored record, for the EPM to offer its data using one of its operating modes.

When a browser is fooled by a Pharming attack to navigate to the wrong website IP address, a non enhanced password manager may still react to a login page of a fraudulent website with confidential data related to the URL of the current website, because a non enhanced password manager has no awareness of the IP address.

One solution could be, storing the IP address alongside the URL in the EPM's database. However, such an obvious solution is not practical as website servers do change their IP addresses or have multiple addresses corresponding to a single domain name.

Alternatively, an EPM could be directed to verify a domain name with a trusted DNS server. This solution, also providing some resolution, delays handling of web pages and is non responsive to Pharming attacks which are local to the device (caused by spyware).

In accordance with the present invention, EPM verifies the authenticity of a current website by verifying an identity assertion made by the website. The method demonstrated here does not require any changes to the server. In fact, the server may not be aware if EMP employs such techniques.

Methods for asserting identity are well known. One common method is based on PKI and proving, by website, the possession of a private key related to a public key which is included in a digitally signed certificate.

We will focus on PKI as a preferred method but, that does not preclude other methods.

In this invention we assume that communication between an EPM and a website are based on a secure channel (https:).

In accordance with a preferred embodiment of the present invention, this is how an enhanced EPM interacts with a legitimate website's login page.

First, EPM needs to store in its database a verification field calculated from a certificate of a website. This first step is carried out during a capture phase of some login credentials. This step must be implemented only when EPM interacts with the site using a trusted link and a trusted computer (no spyware).

EPM retrieves a verified certificate for the current website. A certificate is deemed verified if it did not expire, the chain of certificate issuer(s) digital signatures is verified and the website has proven possession of the private key part of the public key disclosed by the certificate.

A certificate include several fields, the one we preferably use for deriving a verification field is the CN sub-field of the subject field. It usually includes the host+domain of the website. (e.g. www.mydomain.com).

EPM then calculates a verification field by, for example, extracting the domain name from the CN sub-field. It then stores said verification in a data record, also including captured confidential fields like a password.

Alternatively, a different part of a certificate can be used.

Later, when a user logs in to a website, that website presents a login page to EPM using a secure channel, which it establishes through its signed digital certificate.

EPM, again, calculates a verification field from the verified certificate. EPM then looks up a stored record matching said verification field. If one is found, then all is good. Otherwise, EPM can either ignore the form or sound an a lert.

To facilitate graceful handling of various websites, some may not be using a secure channel, EPM then sets a flag in the stored record related to each site. Said flag indicates whether one should expect secure channel authentication from the site. If that flag is not set, EPM may function as a non-enhanced password manager. If the flag is set, then this anti-pharming measure of the present invention kicks in.

During a Pharming attack, an imposter website can copy a certificate from the real site. However, it cannot issue a proof of possession of the private key associated with that certificate. Thus, a Pharming site cannot create a secure channel based on the certificate of a real website.

If an imposter website, tries to present a non verifiable certificate that corresponds to one of the stored record, EPM can issue an alert to indicate a Pharming attack.

Further, if a Pharming site does not use a secure channel wherein EPM expects one, an alert can be issued by EPM.

Once a user is protected from phishing & Pharming, there remains the issue of spyware.

A spyware is a virus like program executing on a user's machine. A spyware can spy on keystrokes (key-loggers), on data entered into forms and on traffic leaving the computer.

With an EPM, we do not care about key-loggers as data can be auto-filled directly into a web form by EPM. Neither do we care about traffic leaving our computer, as a browser employs a secure channel with end to end encryption of a secure session. What we care about is a spying program reading a form just filled by an EPM, before that form is sent out to the target site.

One should note that one cannot rely on the session key established between a browser and the website because that key only encrypts information as it leaves the browser. What is needed is a way to hide confidential data that to be submitted, before the form is even filled by the EPM.

To that end, EPM includes a method wherein confidential data is scrambled before it is made available to be filled in a form. Furthermore, this method imposes minimum changes to existing server side logic and it requires no modifications to a server side database.

Thus, in accordance with a preferred embodiment of the present invention, a website establishing a secure channel (https) with a browser, sends a web page including a web form, to be filled, to a user's machine wherein EPM retrieves related data that it is about to enter (directly or by displaying it to a user who would then copy it to the form) to the form.

At this point, EPM needs to verify whether the website would accept scrambled data in lieu of clear text data. If it does not, then EPM, simply fills-in the form with clear text data. Otherwise, EPM should fill-in the form only with scrambled data.

Such verification cannot be based on any signal or marker sent from the website during the present session. The reason being that we assume the existence of an active spying program against which EPM fights. Such a spying program could alter the received page and remove any signals from said website about its acceptance of scrambled data causing EPM to enter clear-text data and thus defeating the purpose of this method.

Thus, an EPM must rely on a previously stored flag associated with that website, to signal such acceptance. Like with the case of the anti-Pharming method, setting the flag should take place when EPM communicates with said website under, what the user considers to be, a safe and trusted environment.

In fact, it is enough for an EPM to detect this marker once, to be able to set said flag. Further, a website could also indicate an expiration date for such markers, triggering EPM to void such flags when they expire.

If a website, which is marked as accepting scrambled data, wishes to accept clear text for some pages, it can send a ‘no-scramble’ marker. However, such a marker should be digitally signed by the website to prevent a spyware program from faking such an element in the received page.

Once EPM asserts that scrambled data is acceptable, it scrambles retrieved data, exposing said data only after it has been scrambled.

Scrambling is based on a secret key that must be accessible to EPM and to the website's server. Further, scrambling should use a non-replay mechanism for each transmission of the form. Otherwise, a spying program could copy the scrambled form and use it at a later time.

There are many methods by which EPM could scramble retrieved data in a way that would be understood only to said website.

One method is to create an ephemeral shared secret with the website using one of the many methods known in the art for establishing a session key.

In a preferred embodiment of the present invention, there is no need to establish a shared secret before sending a form. Instead, EPM generates a one-time-key to be used for data scrambling. A one-time-key can be computed from a salt value sent by the website's server together with the form to be filled (this will prevent replay attacks) and a random part generated by EPM. The two can be combined to produce the one-time-key.

Using the one time key, EPM encrypts the retrieved data. Alternatively, it can use the one-time-key to hash the data.

Encryption can be used for all data fields. However, some times one just wants to prove the possession of a secret, not to send a copy of (even if it is encrypted). In such cases, hashing can do the trick as EPM hashes the proof secrets and sends an hash value of the secret instead of the encrypted value.

For the website's server to be able to decrypt form data or verify hashed value of fields, it must receive a copy of the one-time-key. Thus, EPM encrypts the one-time-key with the website's public key. The same key used to establish the secure communication channel.

EPM then exposes scrambled data and the encrypted one-time key. The term ‘expose’, as used here, means that said data is exposed to the user as well as any spying program. Exposing can mean displaying of, or it can mean, filling the form.

The form, filled out with scrambled data, is sent to the website where the website's server first decrypts the one-time-key using its private key. It then decrypts encrypted data, or hashes proof of possession data to verify hashed proofs sent by EPM.

One crucial step is for the server to verify that the form was not replayed by a spyware program, having captured the form beforehand.

To that end, EPM should prove to the server that it has used the salt value, sent by the server. One way to do this is for EPM to send also the salt value hashed by the one-time-key. Alternatively, the one-time-key itself can be generated by concatenating the salt with a random value, thus the server can simply look at the one-time-key to verify it includes the salt value.

An alternate, less desirable way, to prevent replays, is for EPM to send a timestamp encrypted by the one-time-key. Or to use a current time stamp in lieu of a salt value.

What is claimed is:

1. A method implemented by an Enhanced Password Manager (EPM) for protecting against Pharming comprising the steps of:
storing a first record pertaining to a first website, wherein said record includes a non empty verification field calculated from the digital certificate of said website;
conditionally retrieving said first stored record at a later time, if said record's verification field matches the certificate of an candidate website, and that certificate is verified.

2. The method of claim 1 wherein the step of conditionally retrieving further comprising:
detecting a login form;
retrieving said first record, matching said candidate website, if the certificate of said website is verified and if said record's verification field matches said certificate;
filling-out said login form with retrieved record data, if retrieval was successful.

3. The method of claim 2 wherein the step of filing out comprises:
scrambling retrieved data to be filled into said form in a manner that can be unscrambled only by the holder of a private key associated with the certificate of said candidate website;
filling out said form with said scrambled data.

4. The method of claim 1 further including the step of issuing an alert if said record's verification field matches a certificate of said candidate website and said certificate fails verification.

5. The method of claim 1 further including the step of storing a key field within said record wherein said key field is derived from the URL of said website.

6. The method of claim 5 further including the step of issuing an alert if a key of a stored record matches the URL of a second website but its verification field does not match the certificate of said candidate website.

7. The method of claim 5 further including the step of issuing an alert if a key of a stored record matches the URL of a second website, it has a non empty verification field and said candidate website does not expose a digital certificate.

8. A method implemented by an Enhanced Password Manager (EPM) for protecting retrieved data from spyware comprising the steps of:
storing a record pertaining to a first website, wherein said record includes a field indicative of said website acceptance of scrambled data as data response; and a non empty verification field calculated from the digital certificate of said first website;
detecting a web form received from a candidate website over secure communication means and verifying the validity of said certificate;
retrieving a stored record of data, whose verification field matches said verified certificate;
scrambling data to be filled into said form, in a manner that can be unscrambled only by the holder of the private key associated with the certificate of said candidate website;
filling out said form with said scrambled data.

9. The method of claim 8 wherein the step of scrambling further comprises:
creating a scrambling key from a first part, received from said candidate website and a first part generated by EPM;
encrypting data with said scrambling key;
encrypting said scrambling key with the public key of said verified certificate and sending encrypted value to said second website.

10. The method of claim 9 further comprising:
receiving scrambled data and encrypted scrambling key by second website;
decrypting scrambling key from its encrypted value with a private key associated with site's certificate;
verifying non-replay of said scrambling key;
decrypting said scrambled data with said scrambling key.

11. The method of claim 8 wherein the step of scrambling further comprises creating a key from a first part derived from a real time stamp and a second part generated by EPM.
